(19) United States
(12) Patent Application Publication
(10) Pub. No.: US 2008/0154394 A1
(43) Pub. Date: Jun. 26, 2008

(54) Bathroom environment remote controller

(75) Inventor: Chun-Hui Lin, Taipei city (TW)

Correspondence Address: TROXELL LAW OFFICE PLLC, SUITE 1404, 5205 LEESBURG PIKE, FALLS CHURCH, VA, 22041, US

(73) Assignee: Hocheng Corporation, Taipei (TW)

(21) Appl. No.: 11/649,880

(22) Filed: Jan. 5, 2007

(30) Foreign Application Priority Data
Dec. 21, 2006 (TW) 095222552

(51) Int. Cl. G05B 15/02

(52) U.S. Cl. 700/83

(57) ABSTRACT

Abstract of the disclosure A remote controller sets up an environment of a bathroom. Water temperature, smell and bathtub function are set with convenience, A person in the bathroom thus feels comfort and relaxed in a bathing.

### FILED OF THE INVENTION

The present invention relates to a remote controller; more particularly, relates to setting a customized water temperature, a desired smell and a requested function of a bathtub for obtaining relaxation and convenience in a bathroom.

### DESCRIPTION OF THE RELATED ART

A bath room generally has bath room facilities, like a shower facility, a toilet seat, a bathtub, a washbowl, etc. for stool, washing or bathing of a user.

Although the above bathroom allows a user to go to a stool or to take a bath or shower, when a warm water is requested, a period of waiting is required for turning on a heater to obtain a hot water; and then hot water is mixed with cool water to obtain the warm water having a requested temperature. During the process, water is wasted and inconvenience is brought forth on using. Besides, when the user wants to apply essence for a smell, bottles of essence or perfume are used to pour essence or perfume into the bathtub. However, it is not so convenient. Moreover, the bathroom then has bottles here and there that forms a mass and occupies space. Hence, the prior art does not fulfill users' requests on actual use.

### SUMMARY OF THE INVENTION

The main purpose of the present invention is to set a customized water temperature, a desired smell and a requested function of a bathtub through an operating device coordinated with an environment control device for obtaining relaxation and convenience in a bathroom.

To achieve the above purpose, the present invention is a bathroom environment remote controller, comprising an operating device and an environment control device, where the operating device has a control unit, an emitting unit, a temperature setting unit, a smell setting unit and a function setting unit; the environment control device receives and operates setting signals from the operating device; the environment control device comprises a processing unit, a receiving unit, a switching unit, a temperature control module, a smell control module and a function control module; and the environment control device has an output corresponding to the smell control module. Accordingly, a novel bathroom environment remote controller is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the opera ting device of the preferred embodiment according to the present invention;

FIG. 2 is the block view showing the operating device;

FIG. 3 is the perspective view showing the environment control device;

FIG. 4 is the block view showing the environment control device;

FIG. 5 is the view showing the state of use;

FIG. 6 is the flow view showing the state of use;

FIG. 7 is the view showing the another state of use;

FIG. 8 is the perspective view showing the another preferred embodiment of the operating device; and

FIG. 9 is the block view showing the another preferred embodiment of the operating device.

### DESCRIPTIONS OF THE PREFERRED EMBODIMENTS

The following descriptions of the preferred embodiments are provided to understand the features and the structures of the present invention.

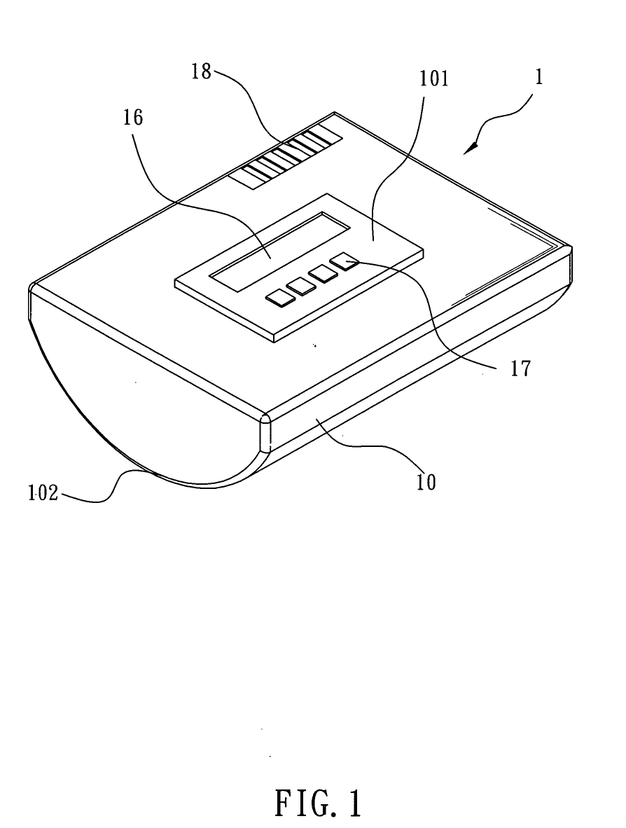

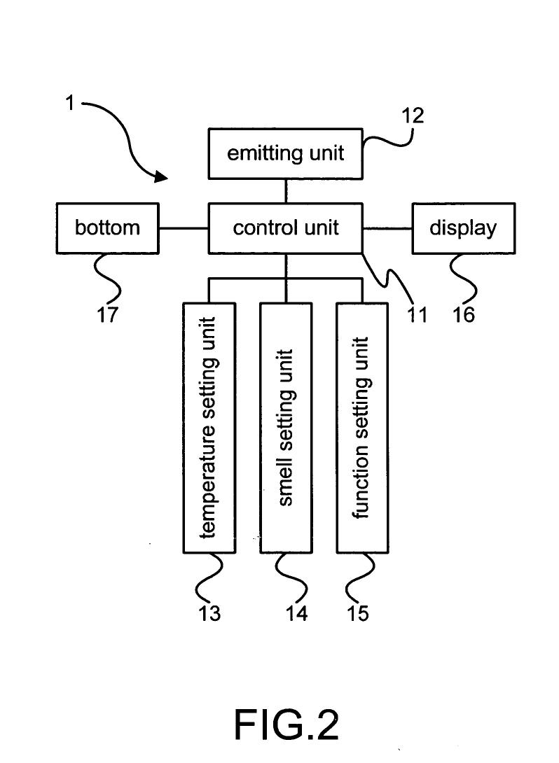

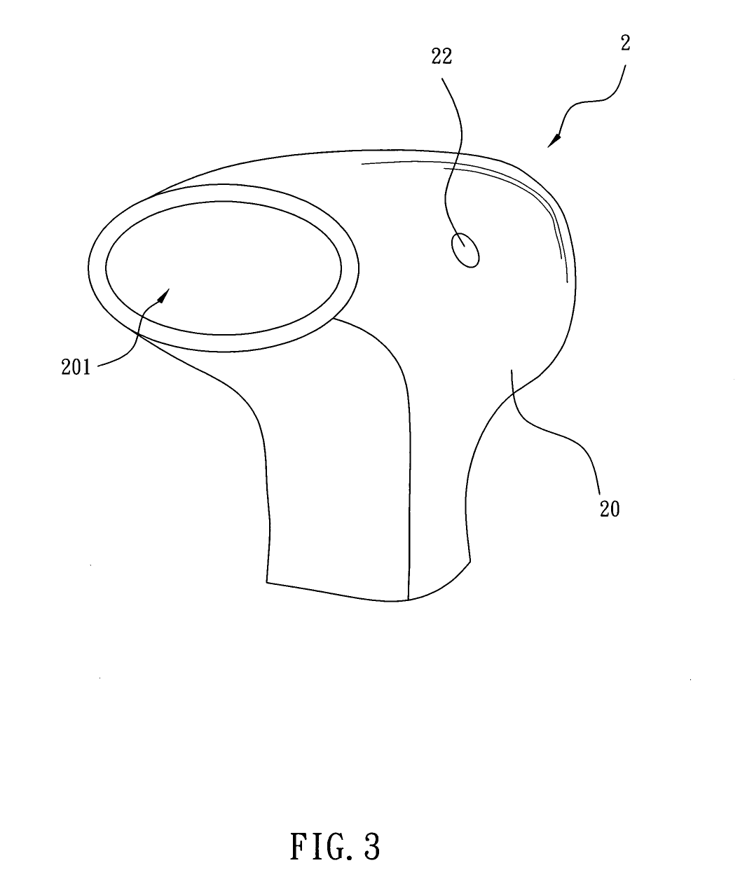

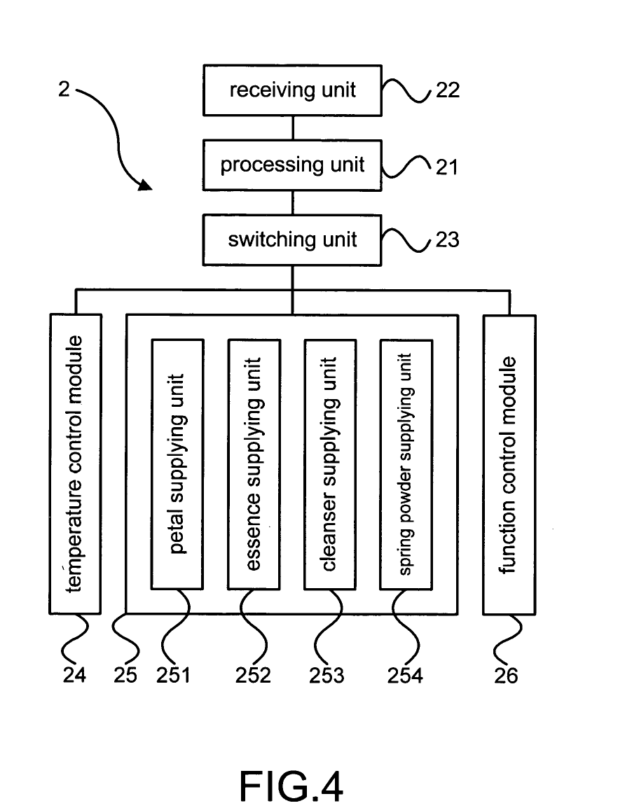

Please refer to FIG. 1 to FIG. 4, which are a perspective view and a block view showing an operating device and a perspective view and a block view showing an environment control device according to a preferred embodiment of the present invention. As shown in the figures, the present invention is a bathroom environment remote controller, comprising an operating device 1 and an environment control device 2, where a customized water temperature, a desired smell and a requested function of a bathtub are set through the operating device 1 coordinated with the environment control device 2; and, so, relaxation and convenience are obtained in a bathroom for a user.

The operating device 1 has a control unit 11; and the control unit 11 is connected with an emitting unit 12, a temperature setting unit 13, a smell setting unit 14 and a function setting unit 15. Therein, the control unit 11, the emitting un it 12, the temperature setting unit 13, the smell setting unit 14 and the function setting unit 15 are located in a shell 10; the shell 10 is made of a heat-resistant material which is light-weighted and rigid; the shell 10 has a panel 101 on an end surface and a curved member 102 on another end surface; the panel 101 has a display 16 and a plurality of bottoms 17 bath connected with the control unit 11; and the operating device 1 is set with a recognition unit 18 to recognize the desired smell.

The environment control device 2 receives setting signals from the operating device 1. The environment control device 2 has a processing unit 21; and the processing unit 21 is connected with a receiving unit 22, a switching unit 23, a temperature control module 24, a smell control module 25 and a function control module 26. Therein, the processing unit 21, the receiving unit 22, the switching unit 23, the temperature control module 24, the smell control module 25 and the function control module 26 are located in a covering unit 20; the covering unit 20 has an output 201 at a side corresponding to the smell control module 25; the emitting unit 11 of the operating device 1 and the receiving unit 22 of the environment control device 2 are ultraviolet communication systems, WIFI communication systems or bluetooth communication systems; and the smell control module 25 comprises a petal supplying unit 251, an essence supplying unit 252, a cleanser supplying unit 253 and a spring powder supplying unit 254. Thus, a novel bathroom environment remote controller is obtained with the above structure.

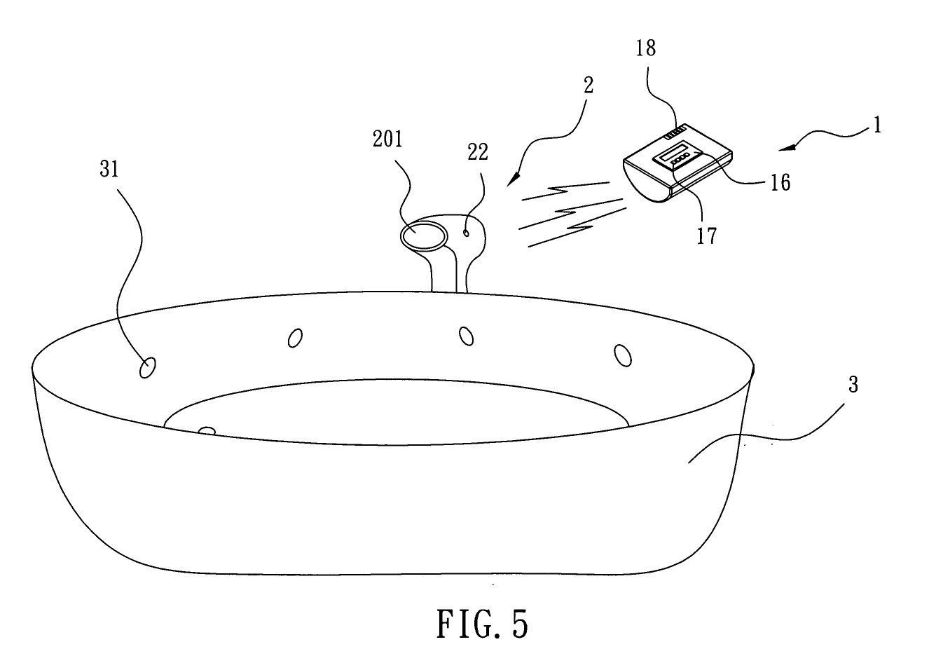

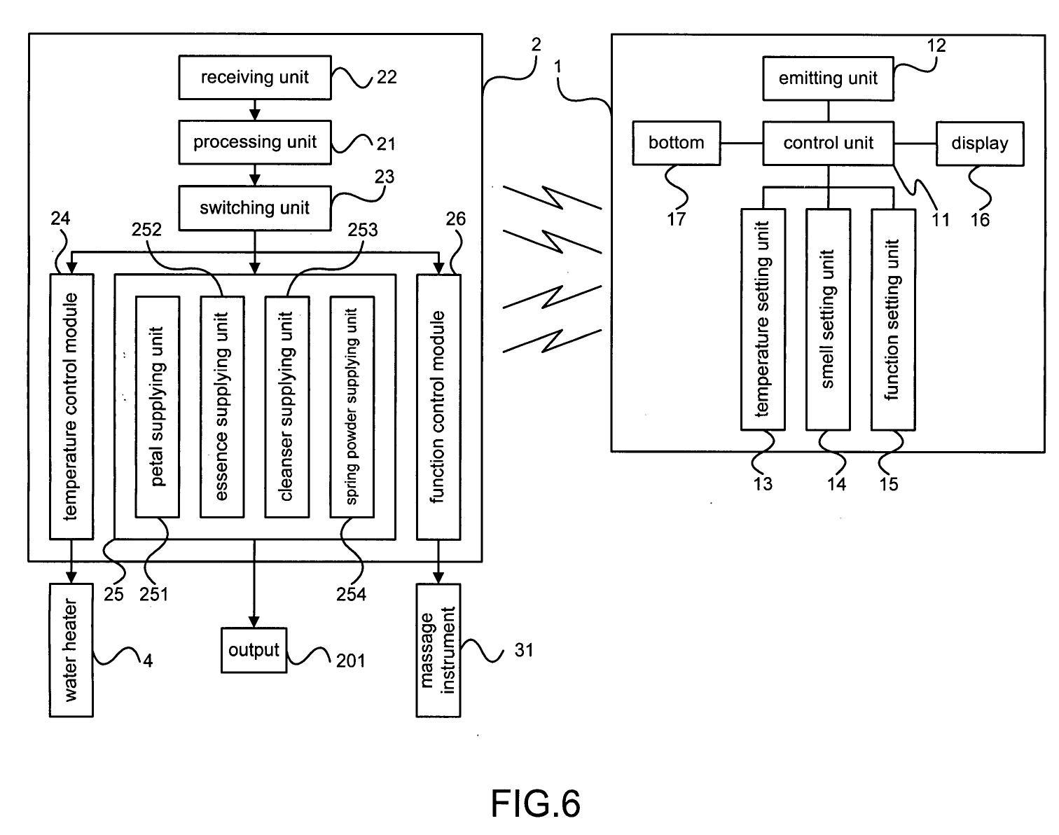

Please refer to FIG. 5 and FIG. 6, which are a perspective view and a flow view showing a state of use. As shown in the figures, when using the present invention, an environment control device 2 is set at a proper position to the bathtub 3; an output 201 of the environment control device 2 is corresponding to the bathtub 3; a temperature control module 24 is connected with a water heater 4; and a function control module 26 is connected with a massage instrument 31 of the bathtub 3.

On using, a bottom 17 on an operating device 1 is pressed to show function options of setting a temperature, a desired smell and a bathtub function on a display 16. Then, a requested setting is chosen through a bottom 17.

On choosing to setup a temperature, the control unit 11 and the temperature setting unit 13 are used to set the temperature through the bottoms 17. Then the temperature setting signals from the operating device 1 a retransmitted by the emitting unit 12 to be received by the receiving unit 22 of the environment control device 2. Then the signals are transferred to the temperature control module 24 through the switching unit 23 by the processing unit 21. Thus, the temperature control module 24 controls the water heater 4 to obtain a proper water temperature.

On choosing to setup a smell, the control unit 11 and a smell setting unit 14 are used to set the smell through bottoms 17. Meanwhile, a recognition unit 18 on the operating device 1 is used to recognize a smell of a smell control module 25. After the smell is confirmed, the smell setting signals from the operating device 1 are transmitted to be received by the receiving unit 22 of the environment control device 2. Then the signals are transferred to the smell control module 25 through a switching unit 23 by the processing unit 21. Thus, the smell control module 25 controls a petal supplying unit 251, an essence supplying unit 252, a cleanser supplying unit 253 and a spring powder supplying unit 254 to provide essence for a smell to the bathtub 3 through the output 201.

On choosing to setup a function of the bathtub 3, the control unit 11 and the function setting unit 15 are used to set the function of the bathtub 3 through bottoms 17, such as turning on a massage instrument 31 of the bathtub 3. Then the function setting signals from the operating device 1 are transmitted by the emitting unit 12 to be received by the receiving unit 22 of the environment control device 2. Then the signals are transferred to the function control module 26 through the switching unit 23 by the processing unit 21. Hence, the function control module 24 controls the bathtub 3, such as the massage instrument 31 of the bathtub 3, to obtain a function.

Thus, a customized water temperature, a desired smell and a requested function of a bathtub are set through the operating device 1 coordinated with the environment control device 2; and, so, relaxation and convenience are obtained for a user.

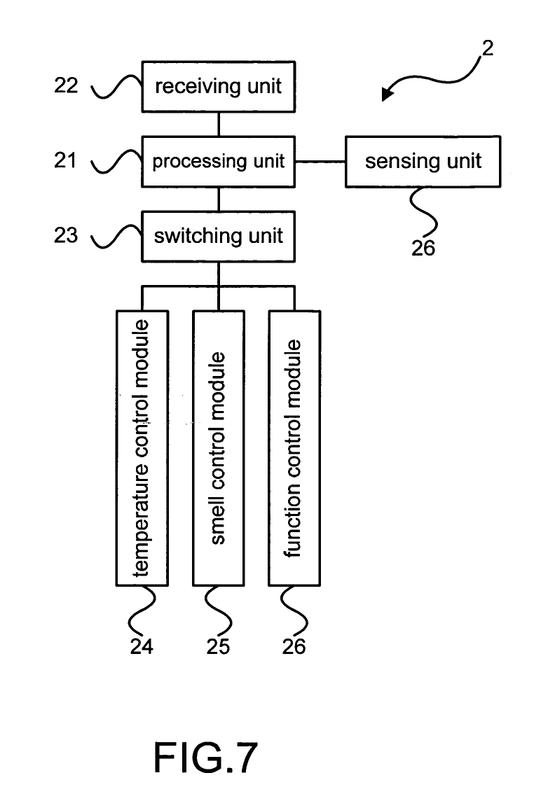

Please refer to FIG. 7, which is a view showing another state of use. As shown in the figure, an environment control device 2 further comprises a sensing unit 27. The sensing unit 27 is connected with a processing unit 21 to sense temperature and smell. After the temperature and the smell are set, the sensing unit 24 senses the water temperature and the smell in the environment; and a switching unit 23 are used to control a temperature control module 23 and a smell control module 24 to keep on running until reaching a standard status. Once the standard status is reached, the processing unit 21 uses the switching unit 23 to control a temperature control module 23 and a smell control module 24 to stop running.

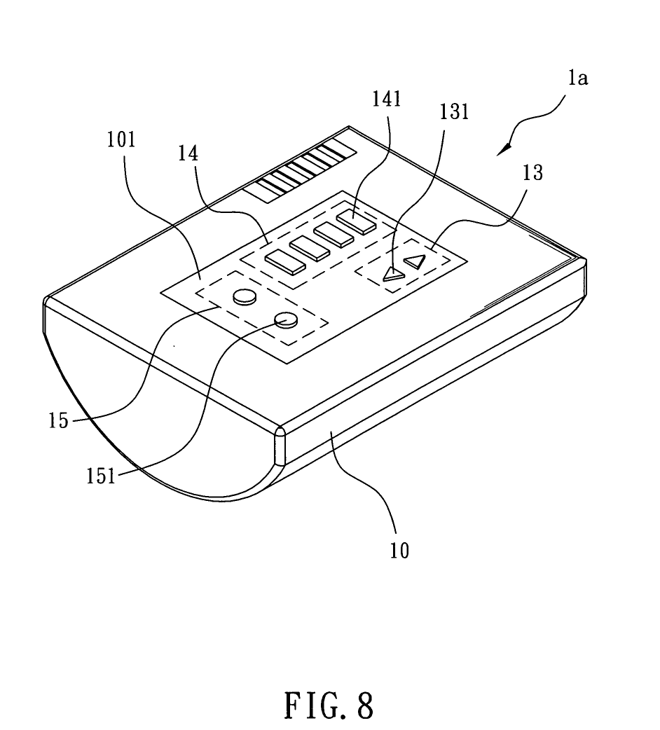

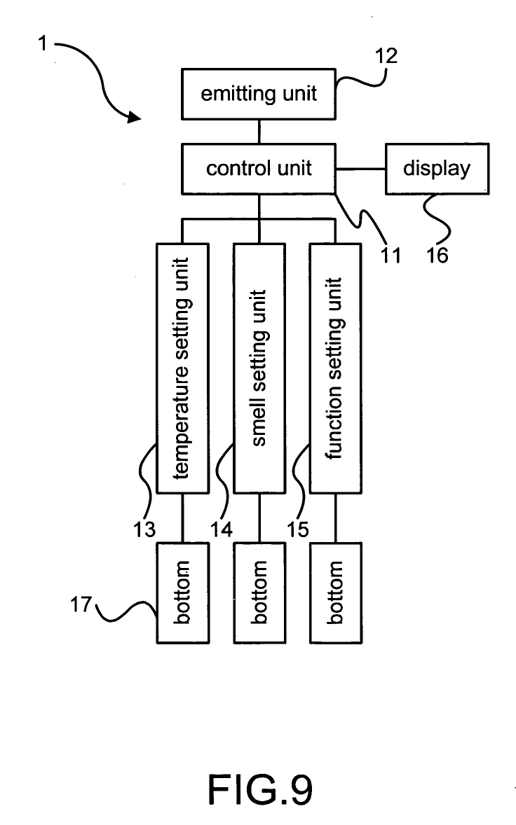

Please refer to FIG. 8 and FIG. 9, which are a perspective view and a block view showing another preferred embodiment of the operating device. An operating device 1a according to the present invention has a plurality of bottoms 131, 141, 151 on a panel 101 directly connected with a temperature setting unit 13, a smell setting unit 14 and a function setting unit 15, so that a customized water temperature, a desired smell and a requested function of a bathtub are set by pressing the bottoms 131, 141, 151.

To sum up, the present invention is a bath room environment remote controller, where a customized water temperature, a desired smell and a requested function of a bathtub are set through an operating device coordinated with an environment control device; and, so, relaxation and convenience are obtained in a bathroom for a user.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A bathroom environment remote controller, comprising:
an operating device, said operating device having a control unit, said control unit connecting to an emitting unit, a temperature setting unit, a smell setting unit and a function setting unit; and
an environment control device, said environment control device receiving and operating setup signals from said operating device, said environment control device having a processing unit, said processing unit connecting to a receiving unit, a switching unit, a temperature control module, a smell control module and a function control module, said environment control device having an output corresponding to said smell control module.

2. The controller according to claim 1
wherein said control unit, said receiving unit, said switching unit, said temperature control module, said smell control module and said function control module are located in a shell;
wherein said shell has a panel on an end surface of said shell;
wherein said panel has a display and a plurality of bottoms; and
wherein said display and said bottoms are connected with said control unit.

3. The controller according to claim 2,
wherein said shell is made of a heat-resistant material; and
wherein said shell has a curved member on another end surface of said shell.

4. The controller according to claim 1,
wherein said control unit, said receiving unit, said switching unit, said temperature control module, said smell control module and said function control module are located in a shell;
wherein said shell has a panel on an end surface of said shell;
wherein said panel has a plurality of bottoms connecting to said temperature control module, said smell control module and said function control module.

5. The controller according to claim 4,
wherein said shell is made of a heat-resistant material; and
wherein said shell has a curved member on another end surface of said shell.

6. The controller according to claim 1
wherein said operating device has a recognition unit corresponding to a smell of said smell control module.

7. The controller according to claim 1
wherein said emitting unit and said receiving unit are ultraviolet communication systems.

8. The controller according to claim 1,
wherein said emitting unit and said receiving unit are WIFI communication systems.

9. The controller according to claim 1,
wherein said emitting unit and said receiving unit are bluetooth communication systems.

10. The controller according to claim 1,
wherein said processing unit, said receiving unit, said switching unit, said temperature control module, said smell control module and said function control module are located in a covering unit; and
wherein said covering unit is connected with an output at a side of said covering unit corresponding to said smell control module.

11. The controller according to claim 1,
wherein said temperature control module is connected with a water heater.

12. The controller according to claim 1,
wherein said smell control module comprises a petal supplying unit, an essence supplying unit, a cleanser supplying unit and a spring powder supplying unit.

13. The controller according to claim 1
wherein said function control module is connected with a massage instrument of a bathtub.

14. The controller according to claim 1,
wherein said environment control device further comprises a sensing unit connected with said processing unit to sense a temperature and a smell.
